(19) United States
(12) Patent Application Publication
(10) Pub. No.: US 2012/0018367 A1
(43) Pub. Date: Jan. 26, 2012

(54) MEMBRANE SEPARATOR

(75) Inventors: Shin-ichiro Wakahara, Hyogo (JP); Hideo Yamashita, Hyogo (JP)

(73) Assignee: KUBOTA CORPORATION, Osaka-shi, Osaka (JP)

(21) Appl. No.: 13/258,549

(22) PCT Filed: Mar. 30, 2010
(86) PCT No.: PCT/JP2010/055644

§ 371 Date: Sep. 22, 2011

(30) Foreign Application Priority Data
Mar. 31, 2009 (JP) 2009-083845

(51) Int. Cl. B01D 65/02; B01D 63/00

(52) U.S. Cl. 210/321.69; 210/321.6

(57) ABSTRACT

A plurality of membrane elements 14 communicate with a water collecting pipe 16 for collecting permeate from the membrane elements 14, and the pipe channel of the water collecting pipe 16 constitutes an upward-inclined channel at least in the upper region of the pipe channel or a channel increased in height in stages at least in the upper region.

### TECHNICAL FIELD

The present invention relates to a membrane separator and a technique for chemical cleaning.

### BACKGROUND ART

In the related art, a membrane separator 1 includes, for example, a membrane module 1 as shown in FIG. 6. The membrane module 1 includes a plurality of plate-like membrane elements 2 vertically arranged parallel to each other, and channels are formed between the plate-like membrane elements 2. The plate-like membrane elements 2 are connected to a water collecting pipe 4 via water conduits 3 such as tubes to collect permeate from the plate-like membrane elements 2 into the water collecting pipe 4. Each of the plate-like membrane elements 2 includes filtration membranes on two sides of a filtration plate, and permeate channels which are formed between the filtration plate and the filtration membranes communicate with the water collecting pipe 4 via the water conduits 3.

A technique for cleaning such a membrane separator is described in, for example, Japanese Patent Application Laid-Open No. 7-256062. In the membrane separator, raw water retained in a treatment tank is filtrated by the membrane separator submerged in the tank, and the water having permeated through the membrane is removed out of the tank through a suction pipe. In cleaning the membrane separator, the internal channel of the membrane separator has been filled with a washing chemical liquid pressure-injected through the suction pipe, and the washing chemical liquid has been infiltrated into the separation membrane from the inner side up to the vicinity of the outer surface thereof over an appropriate period of time.

Further, Japanese Patent Application Laid-Open No. 2005-103406 describes a chemical cleaning device for cleaning the membrane separator submerged in a treatment tank with a chemical. In the chemical cleaning device, a chemical injection pipe is connected to a suction pipe for removing permeate out of the treatment tank, a circulation pipe is provided which branches from the chemical injection pipe and returns to a chemical storage tank, and a delivery pipe is provided in the chemical storage tank to deliver gas contained in the chemical having returned from the circulation pipe to the chemical storage tank.

### SUMMARY OF INVENTION

### Technical Problem

However, in chemical cleaning, when a washing chemical liquid is injected from the water collecting pipe 4 on the secondary side of the membrane separator, that is, the permeate side of the membrane module 1 into the plate-like membrane elements 2, the components of permeate remaining in the plate-like membrane elements 2 of the membrane module 1 may react with the components of the washing chemical liquid to generate gas.

For example, permeate separated through the membrane from digested sludge in a methane fermentation tank contains carbonate ions. When a washing chemical liquid contains acids such as organic acid, carbon dioxide is formed. When the gas is retained on the permeate side such as the water collecting pipe 4 and the water conduits 3 each serving as the supply channel of the washing chemical liquid or the gas moves against the flow of the washing chemical liquid, the flow of the washing chemical liquid is blocked to prevent the supply of a chemical.

The present invention has been devised to solve the problem. An object of the present invention is to provide a membrane separator which can swiftly exhaust gas generated in the membrane separator through the supply passage of a washing chemical liquid.

### Solution to Problem

In order to solve the problem, a membrane separator according to the present invention wherein a plurality of membrane elements communicate with a water collecting part for collecting permeate from the membrane elements, and the internal channel of the water collecting part constitutes an upward-inclined channel at least in the upper region or a channel increased in height in stages at least in the upper region.

Further, a chemical supply pipe for supplying a washing chemical liquid communicates with the lowest portion of the internal channel of the water collecting part, and a gas exhaust pipe for exhausting gas communicates with the highest portion of the internal channel of the water collecting part.

A membrane separator according to the present invention wherein a plurality of membrane elements communicate with lower water collecting parts for collecting permeate from the membrane elements, the lower water collecting parts communicate with an upper water collecting part, and the internal channel of the upper water collecting part constitutes an upward-inclined channel at least in the upper region or a channel increased in height in stages at least in the upper region.

Further, a chemical supply pipe for supplying a washing chemical liquid communicates with the lowest portion of the internal channel of the upper water collecting part, and a gas exhaust pipe for exhausting gas communicates with the highest portion of the internal channel of the upper water collecting part.

A membrane separator according to the present invention wherein a plurality of membrane elements communicate with lower water collecting parts for collecting permeate from the membrane elements, the lower water collecting parts communicate with an upper water collecting part, the internal channels of the lower water collecting parts and the upper water collecting part constitute upward-inclined channels at least in the upper regions or channels increased in height in stages at least in the upper regions, the lowest portions of the internal channels of the lower water collecting parts communicate with the upper water collecting part via connecting portions, a chemical supply pipe for supplying a washing chemical liquid communicates with the lowest portion of the internal channel of the upper water collecting part, and a gas exhaust pipe for exhausting gas communicates with the highest portion of the internal channel of the upper water collecting part and the highest portion of the internal channel of the lower water collecting part.

### Advantageous Effects of Invention

According to the present invention, since the internal channel of the water collecting part constitutes an upward-inclined channel at least in the upper region or a channel increased in height in stages at least in the upper region, and a gas exhaust pipe for exhausting gas communicates with the highest portion of the water collecting part, gas generated in the system of the membrane separator in chemical cleaning flows from the lower point to the higher point of the water collecting part, passes through the gas exhaust pipe, and is swiftly exhausted out of the system. Thus, when a washing chemical liquid is supplied to the water collecting part through the chemical supply pipe, the washing chemical liquid can be smoothly supplied into the plate-like membrane elements without being blocked by the gas in the system.

### BRIEF DESCRIPTION OF DRAWINGS

FIG. 1 is a schematic drawing showing a membrane separator according to an embodiment of the present invention.

FIG. 2 is a schematic drawing showing a membrane separator according to another embodiment of the present invention.

FIG. 3 is a schematic drawing showing a membrane separator according to another embodiment of the present invention.

FIG. 4 is a schematic drawing showing a membrane separator according to another embodiment of the present invention.

FIG. 5 is a schematic drawing showing a membrane separator according to another embodiment of the present invention.

FIG. 6 is a schematic drawing showing a membrane separator according to the related art.

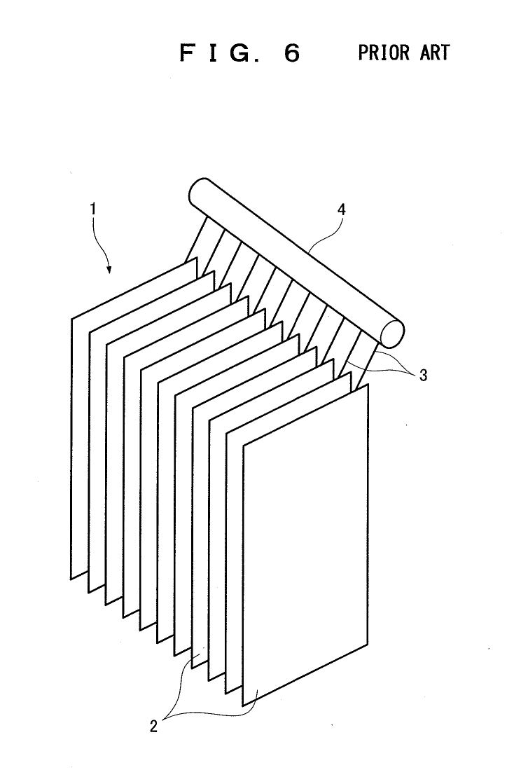

### DESCRIPTION OF EMBODIMENTS

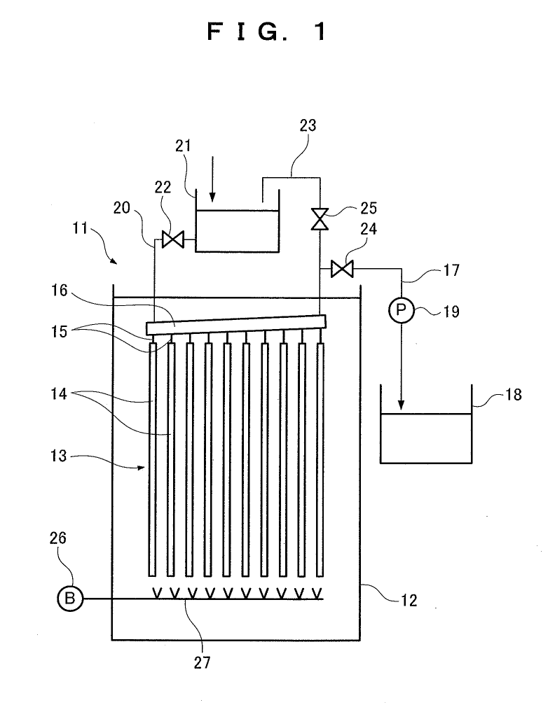

Referring to the accompanying drawings, the following will describe embodiments according to the present invention. A membrane separator 11 includes a membrane module 13 submerged in a tank 12 in FIG. 1 and is used for, for example, activated sludge treatment or methane fermentation. However, the application of the membrane separator 11 is not limited.

The membrane module 13 includes a plurality of plate-like membrane elements 14 vertically arranged parallel to each other, and channels are formed between the plate-like membrane elements 14. The plate-like membrane elements 14 are connected to a water collecting pipe 16 serving as a water collecting part via water conduits 15 such as tubes to collect permeate from the plate-like membrane elements 14 into the water collecting pipe.

The plate-like membrane elements 14 may be directly connected to the water collecting pipe 16. The plate-like membrane element includes a filtration plate and filtration membranes disposed on two surfaces of the filtration plate, and permeate channels formed between the filtration plate and the filtration membranes communicate with the water collecting pipe 16 via the water conduit 15.

The water collecting pipe 16 is upward-inclined from one end side towards another end side, a pipe channel as an internal channel constitutes an upward-inclined channel from the one end side towards the other end side, and at least the upper region of the pipe channel constitutes an upward-inclined channel.

A suction pipe 17 is connected to the other end side which is the highest portion of the water collecting pipe 16, the downstream side of the suction pipe 17 communicates with a permeate storage tank 18, and a suction pump 19 is interposed at a point of the suction pipe 17. A chemical supply pipe 20 for supplying a washing chemical liquid communicates with the one end side which is the lowest portion of the water collecting pipe 16. The upstream side of the chemical supply pipe 20 communicates with a chemical storage tank 21, and a valve 22 is interposed at a point of the chemical supply pipe 20.

A gas exhaust pipe 23 for exhausting gas is connected to the suction pipe 17 on the upstream side of a valve 24 interposed at a point of the suction pipe 17, that is, a side of the valve 24 closer to the membrane module, and communicates with the other end side of the water collecting pipe 16 which is the highest portion via a part of the suction pipe 17. A valve 25 is interposed at a point of the gas exhaust pipe 23. The gas exhaust pipe 23 may be directly connected to the water collecting pipe 16. An air diffuser 27 connected to a blower 26 is provided below the membrane module 13.

Effects in the above-described configuration will be described.

### [Filtration Operation]

The blower 26 is driven to diffuse air from the air diffuser 27 during filtration operation. Due to upflow generated by the air-lift action, a liquid to be treated in the tank 12 is supplied to the channels between the plate-like membrane elements 14. The suction pump 19 is driven with the valves 22 and 25 closed and the valve 24 opened to apply a suction pressure as a driving pressure to the membrane module 13, and membrane separation is performed on the liquid to be treated in the tank 12. Permeate having permeated through the filtration membranes of the plate-like membrane elements 14 of the membrane module 13 flows into the water collecting pipe 16 via the water conduits 15, and is discharged from the water collecting pipe 16 into the permeate storage tank 18 through the suction pipe 17.

### [Chemical Cleaning]

During chemical cleaning, the valves 22 and 25 are opened, the valve 24 is closed and the suction pump 19 and the blower 26 are de-actuated. In this state, a washing chemical liquid is supplied from the chemical storage tank 21 to the water collecting pipe 16 through the chemical supply pipe 20. The washing chemical liquid flows into the permeate channels of the plate-like membrane elements 14 through the respective water conduits 15 while moving from the one end side of the water collecting pipe 16 which is the lowest portion towards the other end side which is the highest portion.

At this point, since the pipe channel of the water collecting pipe 16 constitutes the upward-inclined channel at least in the upper region and the gas exhaust pipe 23 communicates with the other end side of the water collecting pipe 16 which is the highest portion, gas generated in the system of the membrane separator 11 during chemical cleaning, that is, in the pipe channel of the water collecting pipe 16 and the permeate channels of the plate-like membrane elements 14 moves from the lower point towards the higher point of the water collecting pipe 16, passes through the gas exhaust pipe 23, and is swiftly exhausted out of the system. Thus, in supplying a washing chemical liquid to the water collecting pipe 16 through the chemical supply pipe 20, the washing chemical liquid can be smoothly supplied to the plate-like membrane elements 14 without being blocked by gas in the system.

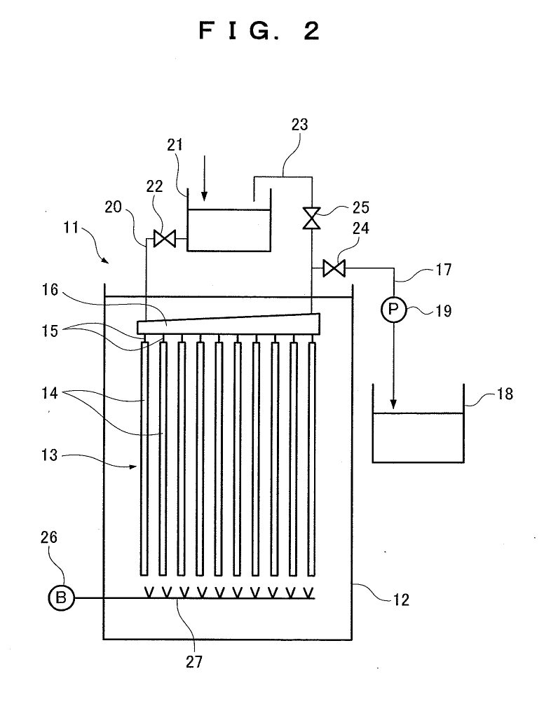

FIG. 2 shows another embodiment according to the present invention. Constituent elements exerting the same effects as those in FIG. 1 are denoted by the same reference numerals, and an explanation thereof is omitted. In the above-described embodiment of FIG. 1, the straight-body water collecting pipe 16 is upward-inclined from the one end side towards the other end side, so that the upward-inclined channel is formed from the one end side towards the other end side as the pipe channel of the water collecting pipe 16. As shown in FIG. 2, however, the pipe channel of the water collecting pipe 16 may constitute the upward-inclined channel only in the upper region. The present invention can be implemented by achieving an upward-inclined channel at least in the upper region of the pipe channel. Further, the water collecting pipe 16 may be formed stepwise. The present invention can be implemented by achieving a channel increased in height in stages at least in the upper region of the pipe channel of the water collecting pipe 16.

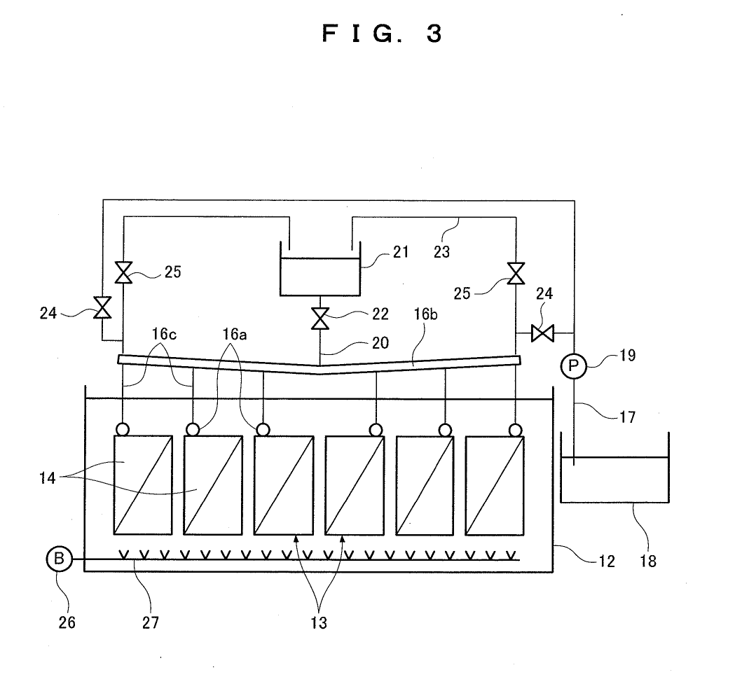

FIG. 3 shows another embodiment according to the present invention. Constituent elements exerting the same effects as those in FIGS. 1 to 2 are denoted by the same reference numerals, and an explanation thereof is omitted.

In FIG. 3, a membrane separator 11 includes a plurality of membrane modules 13, and the membrane module 13 includes plate-like membrane elements 14 communicating with a module water collecting portion 16a serving as a lower water collecting part for collecting permeate from the plate-like membrane elements 14. The module water collecting portions 16a of the membrane modules 13 communicate with an upper water collecting pipe 16b serving as an upper water collecting part via connecting portions 16c. The upper water collecting pipe 16b constitutes an upward-inclined pipe channel from the center portion towards two end sides of the upper water collecting pipe, and at least the upper region of the pipe channel is upward-inclined.

A suction pipe 17 and a gas exhaust pipe 23 are connected to the two end sides of the upper water collecting pipe 16b which are the highest portions, and a chemical supply pipe 20 for supplying a washing chemical liquid communicates with the center portion of the upper water collecting pipe 16b which is the lowest portion.

With this configuration, since the pipe channel of the upper water collecting pipe 16b constitutes the upward-inclined channel at least in the upper region and the gas exhaust pipe 23 communicates with the two end sides of the water collecting pipe 16b which are the highest portions, gas generated during chemical cleaning in the system of the membrane separator 11, that is, in the module water collecting portions 16a, the pipe channel of the upper water collecting pipe 16b, and the permeate channels of the plate-like membrane elements 14 moves from the lower point towards the higher point of the upper water collecting pipe 16b and is swiftly exhausted out of the system through the gas exhaust pipe 23. Thus, in supplying a washing chemical liquid to the water collecting pipe 16b through the chemical supply pipe 20, the washing chemical liquid can be smoothly supplied to the plate-like membrane elements without being blocked by gas in the system.

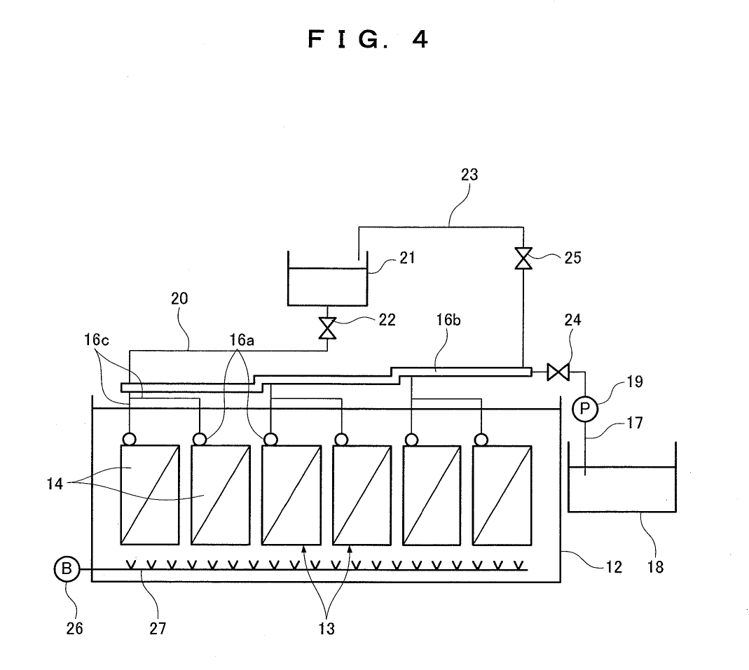

FIG. 4 shows another embodiment according to the present invention. Constituent elements exerting the same effects as those in FIGS. 1 to 3 are denoted by the same reference numerals, and an explanation thereof is omitted. In the above-described embodiment of FIG. 3, the straight-body upper water collecting pipe 16b is upward-inclined from the center portion towards the two end sides, so that the pipe channel of the upper water collecting pipe 16b is upward-inclined from the center portion towards the two end sides. As shown in FIG. 4, however, an upper water collecting pipe 16b may be formed stepwise from one end side towards another end side of the upper water collecting pipe. The present invention can be implemented by achieving a channel increased in height in stages at least in the upper region of the pipe channel of the upper water collecting pipe 16b. Further, the upper water collecting pipe 16b may be inclined from the one end side towards the other end side and constitute an upward-inclined channel only in the upper region of the pipe channel. The present invention can be implemented by achieving an upward-inclined channel at least in the upper region of the pipe channel.

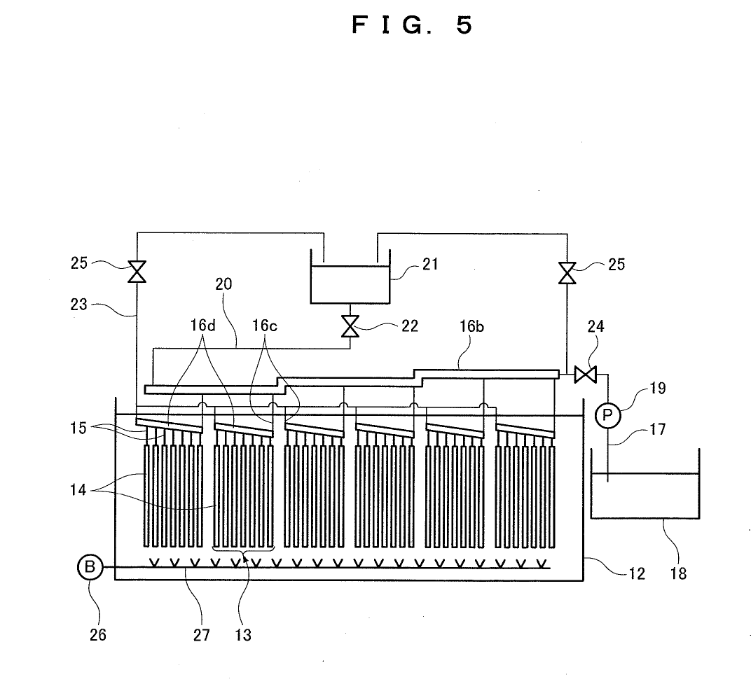

FIG. 5 shows another embodiment according to the present invention. Constituent elements exerting the same effects as those in FIGS. 1 to 4 are denoted by the same reference numerals, and an explanation thereof is omitted.

In FIG. 5, a membrane separator 11 includes a plurality of membrane modules 13, and the membrane module 13 includes a plurality of plate-like membrane elements 14 communicating with a lower water collecting pipe 16d serving as a lower water collecting part for collecting permeate from the plate-like membrane elements 14. The lower water collecting pipes 16d of the membrane modules 13 communicate with an upper water collecting pipe 16b which is located above the lower water collecting pipes 16d and serves as an upper water collecting part via connecting portions 16c. The upper water collecting pipe 16b is formed stepwise from one end side towards another end side of the upper water collecting pipe, and constitutes a channel increased in height in stages at least in the upper region of a pipe channel. The pipe channel of the lower water collecting pipe 16d constitutes an upward-inclined channel from one end side towards another end side of the pipe channel, and the lowest portion of the lower water collecting pipe 16d communicates with the upper water collecting pipe 16b via the connecting portion 16c.

A suction pipe 17 and a gas exhaust pipe 23 communicate with the other end side of the upper water collecting pipe 16b which is the highest portion, the gas exhaust pipe 23 communicates also with the highest portion of the lower water collecting pipe 16d, and a chemical supply pipe 20 for supplying a washing chemical liquid communicates with the one end side of the upper water collecting pipe 16b which is the lowest portion.

With this configuration, since the pipe channels of the lower water collecting pipes 16d and the upper water collecting pipe 16b constitute the upward-inclined channels at least in the upper regions and the gas exhaust pipe 23 communicates with the highest portions of the lower water collecting pipe 16d and the upper water collecting pipe 16b, gas generated during chemical cleaning in the system of the membrane separator 11, that is, in the pipe channels of the lower water collecting pipes 16d and the upper water collecting pipe 16b and the permeate channels of the plate-like membrane elements 14 moves from the lower points towards the higher points of the lower water collecting pipes 16d and the upper water collecting pipe 16b, passes through the gas exhaust pipe 23, and is swiftly exhausted out of the system. Thus, in supplying a washing chemical liquid to the upper water collecting pipe 16b through the chemical supply pipe 20, the washing chemical liquid can be smoothly supplied into the plate-like membrane elements 14 without being blocked by gas in the system.

In the above embodiments, the plate-like membrane element 14 is used but a hollow fiber membrane or ceramic tubular membrane may be used as long as a water collecting part for collecting permeate from the membrane element is provided. The type of the membrane element is not limited.

1. A membrane separator wherein a plurality of membrane elements communicate with a water collecting part for collecting permeate from the membrane elements, and an internal channel of the water collecting part constitutes an upward-inclined channel at least in an upper region or a channel increased in height in stages at least in the upper region.

2. The membrane separator according to claim 1, wherein a chemical supply pipe for supplying a washing chemical liquid communicates with the lowest portion of the internal channel of the water collecting part, and a gas exhaust pipe for exhausting gas communicates with the highest portion of the internal channel of the water collecting part.

3. A membrane separator wherein a plurality of membrane elements communicate with lower water collecting parts for collecting permeate from the membrane elements, the lower water collecting parts communicate with an upper water collecting part, and an internal channel of the upper water collecting part constitutes an upward-inclined channel at least in an upper region or a channel increased in height in stages at least in the upper region.

4. The membrane separator according to claim 3 wherein a chemical supply pipe for supplying a washing chemical liquid communicates with the lowest portion of the internal channel of the upper water collecting part, and a gas exhaust pipe for exhausting gas communicates with the highest portion of the internal channel of the upper water collecting part.

5. A membrane separator wherein a plurality of membrane elements communicate with lower water collecting parts for collecting permeate from the membrane elements, the lower water collecting parts communicate with an upper water collecting part, internal channels of the lower water collecting parts and the upper water collecting part constitute upward-inclined channels at least in upper regions or channels increased in height in stages at least in the upper regions, the lowest portions of the internal channels of the lower water collecting parts communicate with the upper water collecting part via connecting portions, a chemical supply pipe for supplying a washing chemical liquid communicates with the lowest portion of the internal channel of the upper water collecting part, and a gas exhaust pipe for exhausting gas communicates with the highest portion of the internal channel of the upper water collecting part and the highest portion of the internal channel of the lower water collecting part.
